(19) United States
(12) Patent Application Publication
(10) Pub. No.: US 2024/0384676 A1
(43) Pub. Date: Nov. 21, 2024

(54) High Efficiency Thermo-Electric Power Generation for Hybrid Vehicles

(71) Applicant: Barry Doran, Pasadena, TX (US)

(72) Inventor: Barry Doran, Pasadena, TX (US)

(21) Appl. No.: 18/198,284

(22) Filed: May 17, 2023

(51) Int. Cl. F01N 5/02; B60K 6/40; F01N 3/02; F01N 3/04; F02G 5/02; H02K 7/18

(52) U.S. Cl. CPC F01N 5/025; B60K 6/40; F01N 3/0205; F01N 3/043; F02G 5/02; H02K 7/183; B60Y 2200/92; F05D 2220/76

(57) ABSTRACT

The apparatus includes a combustion engine having an exhaust system, a thermal cooling system, and a battery. A first turbine is coupled to the exhaust system and electronically coupled to the battery. A second turbine is fluidly coupled to the thermal cooling system and to the combustion engine. The second turbine is electronically coupled to the battery.

### BACKGROUND

The conservation of energy is a goal for many industries. Scientist and conversationist have made several attempts and have recommended methods to reduce the human created carbon footprint as well as innovate ways to conserve energy or reuse material. One such industry includes the automotive industry. Currently, many automotive industries are moving towards reducing engine sizes from V-8's to smaller turbo charge V-6 engines in most of their standard vehicles. Other automakers are forecasted to transition to hybrid vehicles or pure electric vehicles. Notwithstanding the goals of automakers, there is still a current need to conserve energy while maintaining performance in vehicles. Even with coupling an electric system to a combustion engine or coupling a turbo or supercharger to combustion engines still result in loss of energy, loss of potential power, and more importantly exhaust waste that enters the atmosphere. Maximizing power in combustible engines while reducing the carbon emissions created by the engines is a challenge.

### BRIEF DESCRIPTION OF THE DRAWINGS

FIG. 1 is a perspective view of an apparatus having a combustion engine, a first turbine, and a second turbine.

FIG. 2 is a perspective view of a vehicle having a combustion engine, a first turbine, and a second turbine.

FIG. 3 is an aerial schematic view of an apparatus having a combustion engine, a first turbine, and a second turbine.

FIG. 4 is a perspective view of an apparatus having a combustion engine, an electric traction motor, a traction battery pack, a first turbine, and a second turbine.

FIG. 5 is a perspective view of a vehicle having a combustion engine, an electric traction motor, a traction battery pack, a first turbine, and a second turbine.

FIG. 6 is an aerial schematic view of an apparatus having a combustion engine, an electric traction motor, a traction battery pack, a first turbine, and a second turbine.

FIG. 7 is an aerial schematic view of an apparatus having a combustion engine, a first turbine, and an array of second turbines.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Recycling and repurposing heat generated by a combustion engine is a challenge. Energy components, such as excess heat and fluid, produced by the combustion engine goes unused and is subsequently released into the atmosphere contributing to the problem of global warming. In a combustion engine system, as heat rises from the operation of the combustion engine, pressure from the gas expands within the internal chamber of the engine requiring the need to release the gases through an exhaust system. This is commonly known as enthalpy. Enthalpy is a thermodynamic function of a system, equivalent to the sum of the internal energy of the system plus the product of its volume multiplied by the pressure exerted on it by its surroundings. The release of that fluid gas and heat is wasted energy.

The heat energy produced by a combustion engine is significant. Thus, an opportunity exists to efficiency remove all the useable combustion energy using a turbine generator and recycling that energy into batteries. The desired result is to have heat energy released by the combustion engine to be at the lowest temperature and pressure as possible, which would aid in the reduction of global warming.

Most modern hybrid vehicles have a combustion engine, a cooling system with working fluid, a convection radiator condenser, and a water pump to pump the working fluid around the engine block. Further, most modern hybrid vehicles may also include a convection fan that pushes air across the condenser fins to cool the working fluid, an exhaust system that releases hot carbon dioxide gas and carbon oxide gas and water vapor from the combustion chamber of the engine into the atmosphere. The embodiments described herein provides an apparatus to recapture that wasted energy (i.e., exhaust fluid gas and heat) and recycle it as useful energy.

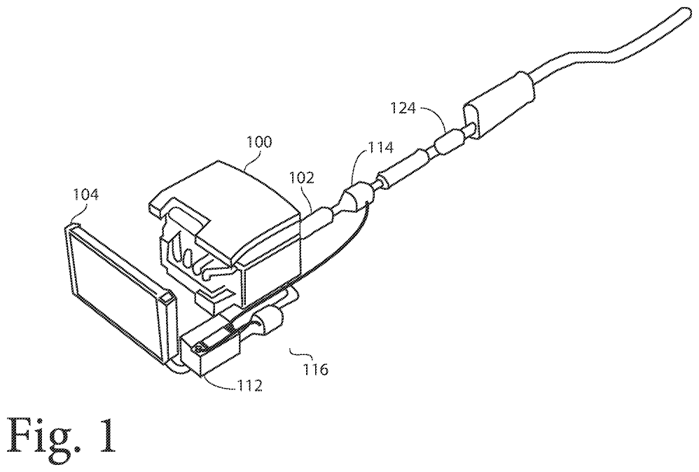

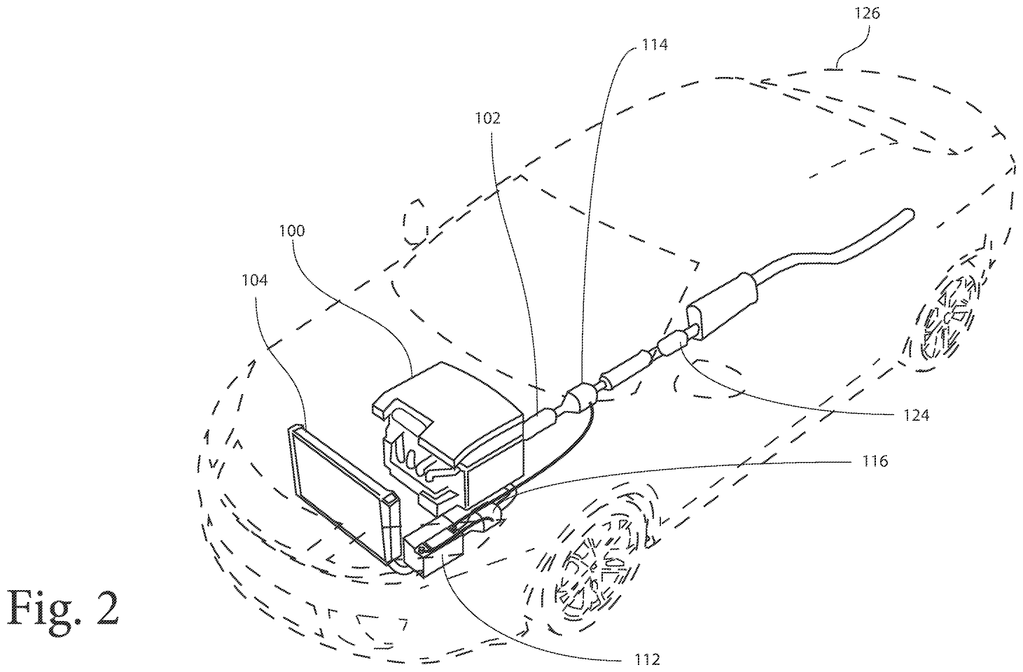

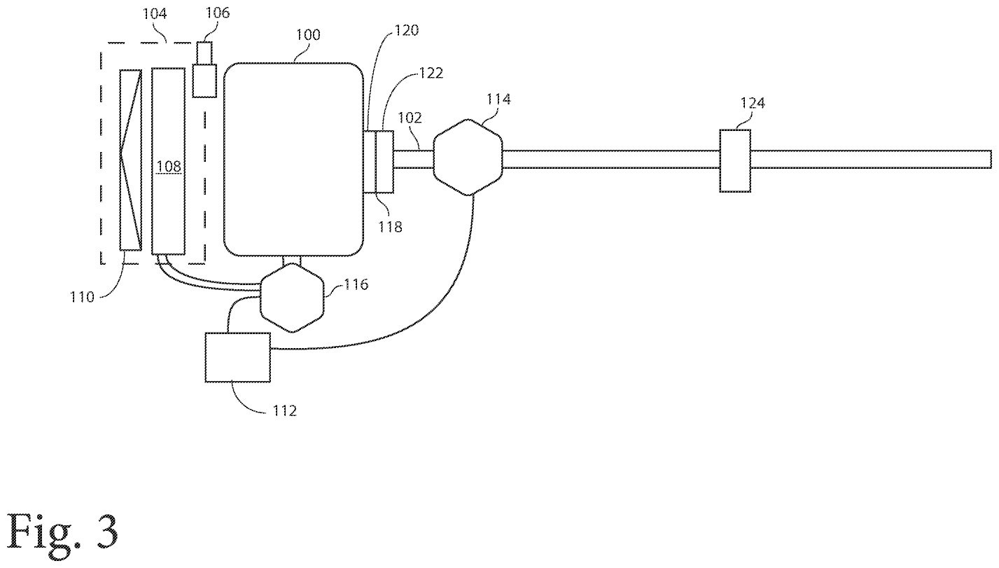

FIG. 1 is a perspective view of an apparatus having a combustion engine, a first turbine, and a second turbine. FIG. 2 is a perspective view of a vehicle having a combustion engine, a first turbine and a second turbine. FIG. 3 is an aerial schematic view of an apparatus having a combustion engine, a first turbine, and a second turbine. As illustrated in FIGS. 1-3 the apparatus includes a combustion engine 100. The combustion engine 100 may be a V6, V8, V10, or V12 engine. The combustion engine 100 may be an inline four- or five-cylinder engine. In one or more embodiments, the combustion engine 100 may be gas, hydrogen, natural gas, or diesel powered. The combustion engine 100 may also include a supercharger.

As further illustrated in FIGS. 1-3, coupled to the combustion engine 100 is an exhaust system 102. The exhaust system 102 may be comprised of several standard components such as a cylinder head, exhaust manifold, turbocharger, catalytic converters, and a muffler for example. The exhaust system 102 is used to guide the reaction exhaust gases away from a controlled combustion inside the combustion engine 100. The exhaust system 102 may include a single exhaust system, a true dual system, a crossmember-back exhaust system, a cat-back exhaust system, a muffler-back exhaust system, or an axle-back exhaust system, for example.

In one or more embodiments, the combustion engine 100 may include a thermal cooling system 104—which includes all the illustrated elements enclosed by the dashed lines. The thermal cooling system 104 maintains a proper operating temperature range of the combustion engine 100. The thermal cooling system 104 may include a set of various parts that allow liquid coolant to flow through the engine block (i.e., combustion engine 100) and the cylinder head passages to absorb some of the heat of combustion. These parts may also include a hydraulic pump 106 and a condenser 108 coupled to the hydraulic pump 106, such that the liquid coolant is pumped through the combustion engine 100 and the thermal cooling system 104. As the liquid coolant absorbs the heat, its temperature increases. The hot coolant is returned to a radiator (which is part of the thermal cooling system 104) through a rubber hose for cooling. When the heated coolant flows into the radiator through a thin tube, it is cooled by the air flow. Thus, the main function of the thermal cooling system 104 is to prevent the combustion engine 100 from overheating. To further aid in the prevention of the combustion engine 100 from overheating, the thermal cooling system 104 may include an onboard air fan 110. The onboard air fan 110 is comprised of fins that rotate pulling outside air and pushing it over and around the combustion engine 100 and through the coils of the condenser radiator 108.

In one or more embodiments, the combustion engine 100 includes a battery 112. The battery 112 is a rechargeable device that is commonly used to start, in part, the combustion engine 100.

As further illustrated in FIGS. 1-3, the apparatus may include a first turbine 114 mechanically coupled to the exhaust system 102 and electronically coupled to the battery 112. The first turbine 114 is a device that harnesses the kinetic energy of some fluid, such as water, steam, air, or combustion gases and turns this into the rotational motion of the device itself, thus generating usable electrical energy to charge the battery 112. In one or more embodiments, the apparatus may also include a second turbine 116 fluidly coupled to the thermal cooling system 104 and to the combustion engine 100 and electronically coupled to the battery 112.

As more clearly illustrated in FIG. 3, the apparatus includes a first heat exchanger 118 coupled to the combustion engine 100 and to the exhaust system 102. A heat exchanger is a device used to transfer heat between a source (i.e., combustion engine 100) and a working fluid (i.e., liquid coolant, air, or combustion gas). In one or more embodiments, the first heat exchanger 118 includes a first chamber 120 fluidly coupled to the combustion engine 100 and a second chamber 122 fluidly coupled to the exhaust system 102. Further, as illustrated in FIGS. 1-3, the apparatus may include a second heat exchanger 124 coupled to the exhaust system 102.

Although FIG. 2 illustrates the apparatus housed in a vehicle 126, the apparatus may be utilized in any mobile vehicle or watercraft that utilizes a combustion engine system, such as a hybrid vehicle, all-terrain vehicle, motorcycles, tractors, boats and other similar vehicles.

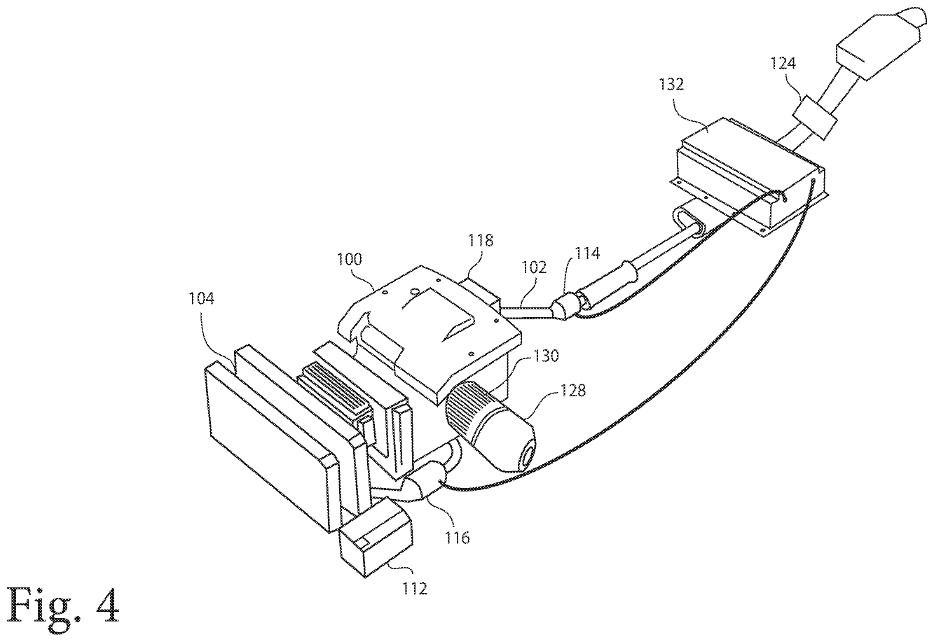

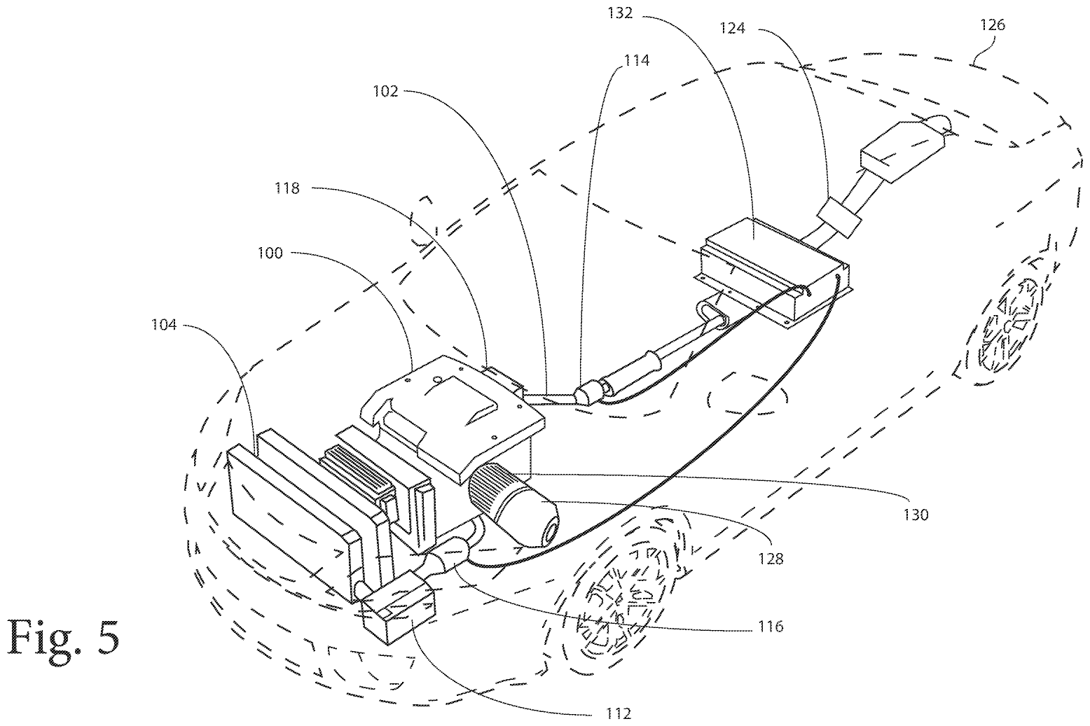

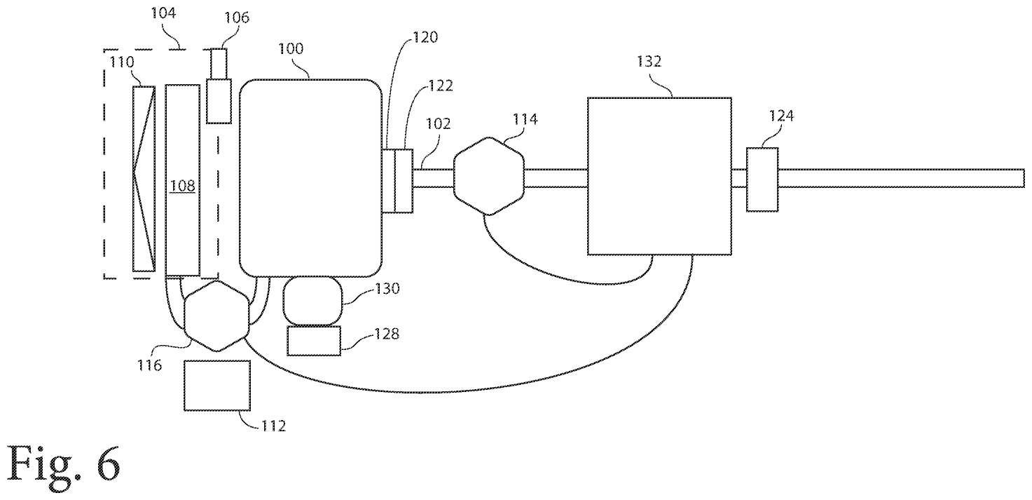

However, in hybrid-vehicle systems, the embodiments described above in connection with FIGS. 1-3 are also included in hybrid systems, except for a few additional embodiments. For example, FIG. 4 is a perspective view of an apparatus having a combustion engine, an electric traction motor, a traction battery pack, a first turbine, and a second turbine. FIG. 5 is a perspective view of a vehicle having a combustion engine, an electric traction motor, a traction battery pack, a first turbine, and a second turbine. FIG. 6 is an aerial schematic view of an apparatus having a combustion engine, an electric traction motor, a traction battery pack, a first turbine, and a second turbine. Note, not every component of a vehicle or hybrid vehicle is described herein but is presumed to exist as part of the preferred embodiments. For example, the transmission, wiring harness, crankshaft, braking system among other embodiments are not described but are presumed to be a part of the system discussed.

The embodiments described in FIGS. 4-6 comprises all the components of FIGS. 1-3, except that FIGS. 4-6 include components applicable to a hybrid vehicle system. For example, in one or more embodiments, the combustion engine 100 includes a generator 128, particularly an electric generator. In one or more embodiments, the generator 128 generates electricity from the rotating wheels of the vehicle 126 while braking, transferring that energy back to a battery (i.e., traction battery pack described below). As further illustrated in FIGS. 4-6, the combustion engine 100 may include an electric traction motor 130 coupled to the generator 128. The electric traction motor 130 uses power from a traction battery pack 132 to drive the vehicle 126 wheels when the combustion engine 100 is deactivated to conserve gas. Further, the traction battery pack 132 is an alternate battery source that stores energy for use by the electric traction motor 130. In one or more embodiments, the traction battery pack 132 is electronically coupled to the electric traction motor 130.

As illustrated in FIGS. 4-6, the hybrid vehicle system may include the first turbine 114 mechanically coupled to the exhaust system 102. In one or embodiments, the first turbine 114 is electronically coupled to the traction battery pack 132. The second turbine 116 may be fluidly coupled to the thermal cooling system 104 and to the combustion engine 100. In one or embodiments, the second turbine 116 is electronically coupled to the traction battery pack 132.

In operation, the method is to remove the pressure and velocity generated by the exhaust system 102 stream by using the first turbine 114. In addition, the method would include removing the exhaust system 102 heat (i.e., heated generated from the combustion engine 100) by transferring the heat to the cooling liquid and then collect it through the second turbine 116 in a Rankine cycle. A Rankine cycle is a process by which certain heat engines allow mechanical work to be extracted from a fluid as it moves between a heat source and a heat sink. This method allows for all the energy, such as velocity energy, pressure-volume energy and heat energy to be absorbed and recycled within the system until the turbine convergent temperature is reached.

The turbine convergent temperature is the temperature wherein the addition of Rankine heat transfer cycles to the stream does not significantly reduce the exit turbine temperature in the Rankine loop. No significant additional energy is produced in the cooling cycle once the turbine convergent temperature is reached. The turbine convergent temperature is dictated by the heat capacity of the materials of the devices and cooling fluid, the ambient temperature, the speed of the fan, the ambient temperature. As long as the combustion engine 100 is producing heat, there is only so much heat that the system can absorb or reject, given that the devices conduct heat and the convective heat transfer in the cooling fluid and into the atmosphere is finite. Eventually, there is not sufficient cooling ability to further cool the stream because the rate of heat generation is balanced by the rate of energy absorbed and there is not a sufficient temperature difference between hot and cold sides to further cool the hot stream. At this point the useful energy has been maximized.

Collecting all energy includes collecting velocity energy, heat energy, and pressure-volume energy. The exhaust provides pressure-volume, velocity, and heat through the tail pipe as the combustion gas is released from the pistons after compression. The heat of the engine block is collected in the cooling working fluid as it flows through the hollow coolant ports in the engine, which are, in one or more embodiments, fed separately to the first heat exchanger 118 and second heat exchanger 124. The gas velocity stream is fed to the turbines where the majority of the pressure-volume energy is collected. Separately, the super-heated coolant vapor (usually water) is sent to turbines to collect some of the energy. The residual heat from the exhaust is collected in consecutive heat exchangers in inner loops where it is sent to multiple subsequent turbines. The final exhaust is subject to turbine convergent temperature that cannot be significantly decreased, and atmospheric pressure that cannot be decreased. In the case where the turbine convergent temperature is achieved all the useable combustion energy has either been absorbed by batteries, converted to locomotion power, or lost to entropy disorder in the conversion from one form of energy to another. A small amount is necessary lost the in the form of convection from the metal surface of the engine in that most engines are not insulated.

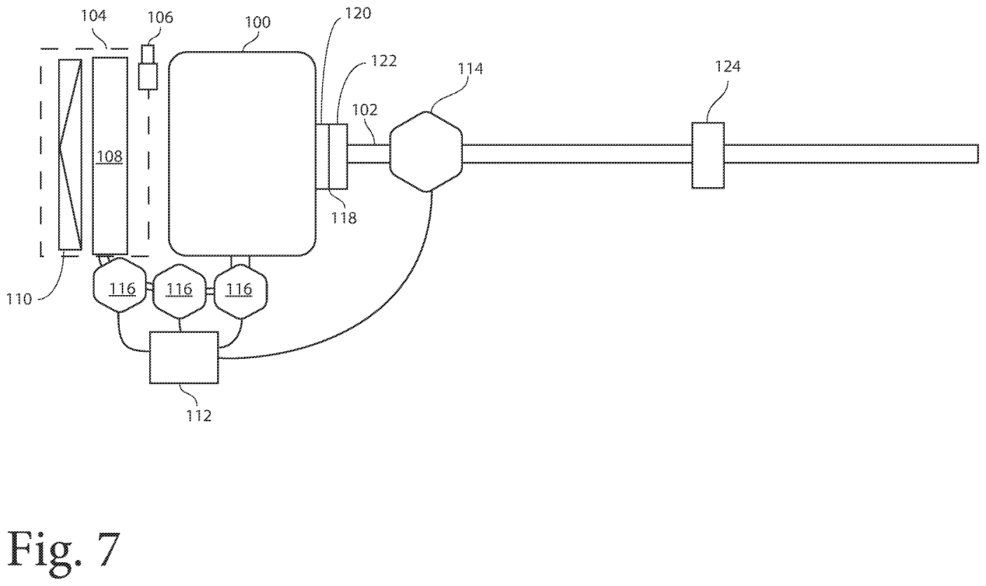

Additional energy can be collected by adding additional turbines. For example, FIG. 7 is an aerial schematic view of an apparatus having a combustion engine, a first turbine, and an array of second turbines. In one or more embodiments, the second turbine 116 may include an array of turbines coupled to the thermal cooling system 104 and to the combustion engine 100. Further, the array of turbines 116 may be electronically coupled to the battery 112 in a combustion engine only system or coupled to the traction battery pack 132 in a hybrid vehicle system. It should also be noted that the final Rankine turbine exit temperature is subject to the convergent temperature that cannot be significantly decreased. The final exhaust gas that is heating the Rankine fluid through the heat exchange could still have a small amount of residual heat and the exhaust gas temperature could still be decreasing even when temperature of the Rankine fluid in the Rankine cycle exiting the Rankine water turbine has already converged to the convergent temperature. That small amount of heat in the exhaust gas gives minimal horsepower seen by the Rankine water turbine even though the Rankine water turbine's exit temperature has an immeasurable decrease, wherein the residual exhaust gas heat is not enough to significantly drive any further horsepower in the associated Rankine water turbine.

In one aspect the apparatus includes a combustion engine having an exhaust system, a thermal cooling system, and a battery. A first turbine is coupled to the exhaust system and electronically coupled to the battery. A second turbine is fluidly coupled to the thermal cooling system and to the combustion engine. The second turbine is electronically coupled to the battery.

Implementations may include one or more of the following. A first heat exchanger may be coupled to the combustion engine and to the exhaust system. The first heat exchanger may include a first chamber fluidly coupled to the combustion engine and a second chamber fluidly coupled to the exhaust system. A second heat exchanger may be coupled to the exhaust system. The thermal cooling system may include a hydraulic pump and a condenser coupled to the hydraulic pump, such that a fluid may be pumped through the combustion engine and the thermal cooling system. The thermal cooling system may include an onboard air fan. The second turbine may include an array of turbines coupled to the thermal cooling system and to the combustion engine. The array of turbines may be electronically coupled to the battery.

In one aspect the apparatus includes a combustion engine having an exhaust system, a thermal cooling system, a battery, and a generator. An electric traction motor is coupled to the generator. A traction battery pack is electronically coupled to the electric traction motor. A first turbine is mechanically coupled to the exhaust system and electronically coupled to the traction battery pack. A second turbine fluidly is coupled to the thermal cooling system and to the combustion engine. The second turbine is electronically coupled to the traction battery pack.

Implementations may include one or more of the following. A first heat exchanger may be coupled to the combustion engine and to the exhaust system. The first heat exchanger may include a first chamber fluidly coupled to the combustion engine and a second chamber fluidly coupled to the exhaust system. A second heat exchanger may be coupled to the exhaust system. The thermal cooling system may include a hydraulic pump and a condenser coupled to the hydraulic pump, such that a fluid may be pumped through the combustion engine and the thermal cooling system. The thermal cooling system may include an onboard air fan. The second turbine may include an array of turbines coupled to the thermal cooling system and to the combustion engine. The array of turbines may be electronically coupled to the battery.

In one aspect the system includes a mobile vehicle having a combustion engine. The combustion engine has an exhaust system, a thermal cooling system, a battery, and a generator. An electric traction motor is coupled to the generator. A traction battery pack is electronically coupled to the electric traction motor. A first turbine is mechanically coupled to the exhaust system and electronically coupled to the traction battery pack. A second turbine is fluidly coupled to the thermal cooling system and to the combustion engine. The second turbine is electronically coupled to the traction battery pack.

Implementations may include one or more of the following. A first heat exchanger may be coupled to the combustion engine and to the exhaust system. The first heat exchanger may include a first chamber fluidly coupled to the combustion engine and a second chamber fluidly coupled to the exhaust system. A second heat exchanger may be coupled to the exhaust system. The thermal cooling system may include a hydraulic pump and a condenser coupled to the hydraulic pump, such that a fluid may be pumped through the combustion engine and the thermal cooling system. The thermal cooling system may include an onboard air fan. The second turbine may include an array of turbines coupled to the thermal cooling system and to the combustion engine. The array of turbines may be electronically coupled to the battery.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An apparatus comprising:
a combustion engine having:
an exhaust system;
a thermal cooling system; and
a battery;
a first turbine mechanically coupled to the exhaust system and electronically coupled to the battery; and
a second turbine fluidly coupled to the thermal cooling system and to the combustion engine and electronically coupled to the battery.

2. The apparatus of claim 1 comprising a first heat exchanger coupled to the combustion engine and to the exhaust system.

3. The apparatus of claim 2 wherein the first heat exchanger comprises:
a first chamber fluidly coupled to the combustion engine; and
a second chamber fluidly coupled to the exhaust system.

4. The apparatus of claim 1 comprising a second heat exchanger coupled to the exhaust system.

5. The apparatus of claim 1 wherein the thermal cooling system comprising:
a hydraulic pump; and
a condenser coupled to the hydraulic pump, such that a fluid is pumped through the combustion engine and the thermal cooling system.

6. The apparatus of claim 1 wherein the thermal cooling system includes an onboard air fan.

7. The apparatus of claim 1 wherein the second turbine includes an array of turbines coupled to the thermal cooling system and to the combustion engine and electronically coupled to the battery.

8. An apparatus comprising:
a combustion engine having:
an exhaust system;
a thermal cooling system;
a battery; and
a generator
an electric traction motor coupled to the generator;
a traction battery pack electronically coupled to the electric traction motor;
a first turbine mechanically coupled to the exhaust system and electronically coupled to the traction battery pack; and
a second turbine fluidly coupled to the thermal cooling system and to the combustion engine and electronically coupled to the traction battery pack.

9. The apparatus of claim 8 comprising a first heat exchanger coupled to the combustion engine and to the exhaust system.

10. The apparatus of claim 9 wherein the first heat exchanger comprises:
a first chamber fluidly coupled to the combustion engine; and
a second chamber fluidly coupled to the exhaust system.

11. The apparatus of claim 8 comprising a second heat exchanger coupled to the exhaust system.

12. The apparatus of claim 8 wherein the thermal cooling system comprising:
a hydraulic pump; and
a condenser coupled to the hydraulic pump, such that a fluid is pumped through the combustion engine and the thermal cooling system.

13. The apparatus of claim 8 wherein the thermal cooling system includes an onboard air fan.

14. The apparatus of claim 8 wherein the second turbine includes an array of turbines coupled to the thermal cooling system and to the combustion engine and electronically coupled to the battery.

15. A system comprising:
a mobile vehicle having:
a combustion engine having:
an exhaust system;
a thermal cooling system;
a battery; and
a generator
an electric traction motor coupled to the generator;
a traction battery pack electronically coupled to the electric traction motor;
a first turbine mechanically coupled to the exhaust system and electronically coupled to the traction battery pack; and
a second turbine fluidly coupled to the thermal cooling system and to the combustion engine and electronically coupled to the traction battery pack.

16. The apparatus of claim 15 comprising a first heat exchanger coupled to the combustion engine and to the exhaust system.

17. The apparatus of claim 16 wherein the first heat exchanger comprises:
a first chamber fluidly coupled to the combustion engine; and
a second chamber fluidly coupled to the exhaust system.

18. The apparatus of claim 15 comprising a second heat exchanger coupled to the exhaust system.

19. The apparatus of claim 15 wherein the thermal cooling system comprising:
a hydraulic pump; and
a condenser coupled to the hydraulic pump, such that a fluid is pumped through the combustion engine and the thermal cooling system.

20. The apparatus of claim 15 wherein the thermal cooling system includes an onboard air fan.
